(19) United States
(12) Patent Application Publication
(10) Pub. No.: US 2017/0262529 A1
(43) Pub. Date: Sep. 14, 2017

(54) SPONSOR ANSWERS AND USER-APPROVED, SYSTEM-SUGGESTED LINKS IN A SOCIAL SEARCH ENGINE

(71) Applicant: Google Inc., Mountain View, CA (US)

(72) Inventors: Nicholas Chim, San Francisco, CA (US); Damon Horowitz, San Francisco, CA (US); Max Ventilla, San Francisco, CA (US); Robert J. Spiro, San Francisco, CA (US)

(21) Appl. No.: 15/062,472

(22) Filed: Mar. 7, 2016

Related U.S. Application Data
(63) Continuation of application No. 13/195,166, filed on Aug. 1, 2011, now abandoned.
(60) Provisional application No. 61/388,705, filed on Oct. 1, 2010.

(51) Int. Cl. G06F 17/30; G09B 7/02

(52) U.S. Cl. CPC G06F 17/30684; G06F 17/30663; G09B 7/02

(57) ABSTRACT

Methods, systems, and apparatus, including computer programs encoded on a non-transitory computer storage medium, for enhancing asker and answerer interaction within a social search service environment. In one aspect, a system includes a computer-readable medium having instructions stored thereon which, when executed, cause one or more computers to perform operations comprising receiving an answer from a first user in response to a question from a second user in a social search service environment, identifying a set of suggested hyperlinks associated with the received answer, providing the set of suggested hyperlinks to the first user, and receiving a selection of at least one of the set of suggested hyperlinks from the first user. The operations may further comprise providing a combined response to the second user, the combined response including the answer and the at least one selected suggested hyperlink.

### CROSS-REFERENCE TO RELATED APPLICATIONS

This application is a continuation of U.S. patent application Ser. No. 13/195,166, entitled “Sponsor Answers and User-Approved, System-Suggested Links in a Social Search Engine,” filed Aug. 1, 2011, which claims the benefit under 35 U.S.C. §119(e) of U.S. Patent Application No. 61/388,705, entitled “Sponsor Answers and User-Approved, System-Suggested Links in a Social Search Engine,” filed Oct. 1, 2010, which are incorporated herein by reference in their entirety.

### BACKGROUND

This specification generally relates to question and answer systems.

Traditionally, the basic paradigm in information retrieval (IR) has been the library. Indeed, the field of IR has roots in the library sciences. While this paradigm has clearly worked well in several contexts, it ignores another age-old model for knowledge acquisition, known as “the village paradigm.” In a village, knowledge dissemination is achieved socially—information is passed from person to person, and the retrieval task consists of finding the right person, rather than the right document, to answer a question.

### SUMMARY

This specification describes technologies relating to systems and methods for enhancing asker and answerer interaction within a social search service environment.

In general, one innovative aspect of the subject matter described in this specification can be embodied in methods that include a system comprising one or more computers and a computer-readable medium coupled to the one or more computers having instructions stored thereon which, when executed by the one or more computers, causes the one or more computers to perform operations comprising (i) receiving an answer from a first user in response to question from a second user in a social search service environment, (ii) identifying a set of suggested hyperlinks associated with the received answer, (iii) providing the set of suggested hyperlinks to the first user, and (iv) receiving a selection of at least one of the set of suggested hyperlinks from the first user. Other embodiments of this aspect include corresponding methods, apparatus, and computer programs, configured to perform the operations of the system, encoded on non-transitory computer storage devices.

These and other embodiments can each optionally include one or more of the following features. For example, the operations may further comprise providing a combined response to the second user, the combined response including the answer and the at least one selected suggested hyperlink. The question from the second user can be a question in a natural language format submitted via the social search service environment. The answer from the first user is a natural language answer to the question from the second user. The answer from the first user further includes at least one of an image, an audio file, a video file, or an audio/video file. The operations can further comprise (i) receiving the question from the second user, (ii) analyzing the question to determine at least one domain associated with the question, and (iii) identifying at least one user in the social search service environment associated with the at least one domain. Identifying at least one user in the social search service environment can include (i) comparing the at least one domain associated with the question to a set of profiles of users within the social search service environment, (ii) identifying a set of user profiles within the set of profiles associated with the at least one domain, and (iii) ranking each of the set of user profiles based at least in part on an availability analysis of the associated user corresponding to the user profile. The operations can further comprise identifying a location related to the question from the second user and identifying a set of user profiles within the set of profiles associated with the at least one domain can further include identifying a set of user profiles within the set of profiles associated with the identified location. Identifying at least one user in the social search service environment can further include providing the question to the highest ranked user for answering, where the highest ranked user is the first user.

Identifying the set of suggested hyperlinks associated with the answer can include identifying at least one keyword phrase in the answer for comparison to a document index, providing the at least one keyword phrase as input for comparison with the document index, and returning at least one search result hyperlink from the document index based on the at least one identified keyword phrase. The document index can be associated with a web search engine, and providing the at least one keyword phrase as input for comparison with the document index can include providing the at least one keyword phrase as input to the web search engine. Identifying the set of suggested hyperlinks associated with the answer can include identifying at least one keyword phrase in the answer, matching the at least one identified keyword phrase to a set of sponsored keywords, where each sponsored keyword is associated with a sponsored hyperlink, and returning at least one sponsored hyperlink associated with the at least one identified keyword phrase. The set of suggested hyperlinks can be provided to the first user after providing the answer to the second user. The operations can further comprise receiving the question from the second user in a first format, converting the question from the first format to a normalized format associated with the social search service environment, and, prior to providing the combined response to the second user, converting the combined response into the first format.

In general, another aspect of the subject matter described in this specification can be embodied in a system comprising one or more computers and a computer-readable medium coupled to the one or more computers having instructions stored thereon which, when executed by the one or more computers, causes the one or more computers to perform operations comprising (i) obtaining a question from an asking user, (ii) analyzing the question to determine a set of information associated with the question, (iii) identifying a set of sponsors associated with a bid for at least a portion of the determined information associated with the question, (iv) ranking the set of sponsors based at least in part on a weighted combination of bids by a particular sponsor for at least a portion of the determined information and a projected quality of answer from the particular sponsor, and providing an opportunity to answer the question to at least one of the set of sponsors based on the sponsor's respective rank among the set of sponsors.

These and other embodiments can each optionally include one or more of the following features. For example, the operations can further comprise receiving at least one answer to the question from at least one of the set of sponsors to whom an opportunity to answer the question is provided and providing at least one received answer to the question to the asking user. The system can be associated with a social search environment, and obtaining a question from a user can include (i) receiving the question from the asking user in a first format, (ii) and converting the question from the first format to a second format used in the social search service environment, while providing the at least one received answer to the question to the asking user can include (i) converting the at least one received answer to the question from the second format used in the social search service environment to the first format, and (ii) sending the at least one received answer to the asking user in the first format. Analyzing the question to determine a set information associated with the question can include (i) parsing the question for at least one keyword or phrase, (ii) comparing the at least one keyword or phrase to a topic classification taxonomy, and (iii) identifying, based on the comparison, at least one topic from the topic classification taxonomy associated with the question. Analyzing the question to determine a set of information associated with the question can further include (i) identifying at least one semantically similar topic to the identified at least one topic from the topic classification taxonomy, and (ii) associating the at least one semantically similar topic to the question. Analyzing the question to determine a set of information associated with the question can further include (i) parsing the question to identify at least one location-sensitive keyword or phrase and (ii) associating the question with a topic associated with the location-sensitive keyword or phrase.

Ranking the set of sponsors can be further based at least in part on a determination of real-time availability of each sponsor. The determination of real-time availability for a particular sponsor can include identifying at least one operator associated with the sponsor, where each operator is capable of answering questions submitted to the sponsor, and determining whether at least one operator associated with the sponsor is available to answer the question in real-time. The bid for at least one of the topics can include a bid submitted by a sponsor for the occurrence of an event within the social search service environment. The occurrence of the event within the social service environment can include at least one of the following: (i) an opportunity for the sponsor to answer a question associated with a particular topic, (ii) a provision of the sponsor's answer to a question associated with a particular topic to the asking user, and (iii) an initiation of business between the sponsored user and the asking user after provision of the sponsor's answer to the asking user. The projected quality of answer from the particular sponsor is calculated based on one or more of the following: (i) a set of topics identified by the particular sponsor as topics for which the sponsor has expertise, (ii) a set of feedback information from at least one user based on previous answers provided by the particular sponsor, and (iii) information on previous successful answers and associated topics provided by the particular sponsor. Analyzing the question to determine a set of information associated with the question can include (i) retrieving an asking user-supplied tag included in the question, (ii) identifying at least one topic from a topic classification taxonomy associated with the user-supplied tag, and (iii) associating the at least one identified topic with the question.

Particular embodiments of the subject matter described in this specification can be implemented so as to realize one or more of the following advantages. Professional answerers, such as businesses and other entities with a monetary interest in providing answers and information (e.g., as experts, for transactional purposes, and for brand-building purposes, etc.), can identify one or more categories in which they provide particular goods or services, and can be identified by a particular category of specialized or advanced knowledge. By connecting the professional answerers to users asking questions related to those categories (or askers), better and more sophisticated answers can be provided to the inquiring users. Additionally, the provision of an answer in the social search service environment can lead to further interactions between the professional answerer and the asker. For example, when the asker receives a helpful response to a question, that interaction can be leveraged by the professional answerer to generate business through additional interactions and transactions associated with the original question. Confidence provided by the professional answers capable within a social search service environment allows the askers to be more receptive to entering into business or related transactions with professional answerers. Another advantage of the present disclosure is the ability of askers to find an active participant within the social search service environment available to provides answers in real-time (e.g., during a single chat session), where the active participant is fully capable of providing detailed answers and solutions to the asker's questions or other queries. Businesses and other entities can place bids on certain categories within which they may be best suited to answer questions to identify and pursue potential business opportunities in a low stress, non-traditional setting.

Still further, user-approved hyperlinks and resources suggested by the system described herein provide additional advantages. In one aspect, the user-approved hyperlinks allow answerers, including professional answerers and normal, or personal, answerers, to provide additional information with their responses in the social search service environment. As one advantage, the asker can receive additional information and resources that may not have otherwise been available, while the answerer can identify additional materials without requiring the answerer to actively perform a search before answering. Further, the answerer may be provided with more relevant information on a particular analyzed question that previously known, thereby enhancing the answerer' s knowledge base and likely enhancing the answerer's future answers and responses. Further, the intimacy of the social search service paradigm increases the likelihood that an asker will consider and review the user-suggested hyperlinks when reviewing a received answer, thus increasing the likelihood of monetization associated with the user-suggested hyperlinks. Still further, by incorporating the user-suggested hyperlinks into a responsive answer prepared by the answerer, the asker's trust in the received user-suggested hyperlinks is increased. The user-approved hyperlinks and resources can allow searches performed via a search engine or other traditional mechanism can be reviewed and approved by human intelligence prior to providing those results to the asker. Because an individual is presented with the suggested hyperlinks and resources prior to providing the hyperlinks to the asker, any hyperlinks or resources selected by the answerer and provided to the asker are likely to be more relevant, as a whole, than those hyperlinks or resources returned by the search engine without human review.

In general, another aspect of the subject matter described in this specification can be embodied in an article comprising a non-transitory computer readable storage medium, the computer readable storage medium storing instructions for causing one or more processors to perform operations including: (i) receiving an answer from a first user in response to question from a second user in a social search service environment; (ii) identifying a set of suggested hyperlinks associated with the received answer; (iii) providing the set of suggested hyperlinks to the first user; and (iv) receiving a selection of at least one of the set of suggested hyperlinks from the first user.

These and other embodiments can each optionally include one or more of the following features. For example, the operations can further comprise providing a combined response to the second user, where the combined response includes the answer and the at least one selected suggested hyperlink. The operations can also further comprise (i) receiving the question from the second user; (ii) analyzing the question to determine at least one domain associated with the question; and (iii) identifying at least one user in the social search service environment associated with the at least one domain. Identifying at least one user in the social search service environment can include (i) comparing the at least one domain associated with the question to a set of profiles of users within the social search service environment; (ii) identifying a set of user profiles within the set of profiles associated with the at least one domain; and (iii) ranking each of the set of user profiles based at least in part on an availability analysis of the associated user corresponding to the user profile. Identifying the set of suggested hyperlinks associated with the answer can include (i) identifying at least one keyword phrase in the answer; (ii) matching the at least one identified keyword phrase to a set of sponsored keywords, where each sponsored keyword is associated with a sponsored hyperlink; and (iii) returning at least one sponsored hyperlink associated with the at least one identified keyword phrase.

In general, another aspect of the subject matter described in this specification can be embodied in a computer-implemented method comprising (i) receiving an answer from a first user in response to question from a second user in a social search service environment; (ii) identifying a set of suggested hyperlinks associated with the received answer; (iii) providing the set of suggested hyperlinks to the first user; and (iv) receiving a selection of at least one of the set of suggested hyperlinks from the first user.

These and other embodiments can each optionally include one or more of the following features. For example, the method may further comprise (i) receiving the question from the second user; (ii) analyzing the question to determine at least one domain associated with the question; and (iii) identifying at least one user in the social search service environment associated with the at least one domain. Identifying at least one user in the social search service environment can include (i) comparing the at least one domain associated with the question to a set of profiles of users within the social search service environment; (ii) identifying a set of user profiles within the set of profiles associated with the at least one domain; and (iii) ranking each of the set of user profiles based at least in part on an availability analysis of the associated user corresponding to the user profile. Identifying the set of suggested hyperlinks associated with the answer can include (i) identifying at least one keyword phrase in the answer; (ii) matching the at least one identified keyword phrase to a set of sponsored keywords, where each sponsored keyword is associated with a sponsored hyperlink; and (iii) returning at least one sponsored hyperlink associated with the at least one identified keyword phrase.

In general, another aspect of the subject matter described in this specification can be embodied in an article comprising a non-transitory computer readable storage medium, the computer readable storage medium storing instructions for causing one or more processors to perform operations including: (i) obtaining a question from an asking user; (ii) analyzing the question to determine a set of information associated with the question; (iii) identifying a set of sponsors associated with a bid for at least a portion of the determined information associated with the question; (iv) ranking the set of sponsors based at least in part on a weighted combination of bids by a particular sponsor for at least a portion of the determined information and a projected quality of answer from the particular sponsor; and (v) providing an opportunity to answer the question to at least one of the set of sponsors based on the sponsor's respective rank among the set of sponsors.

These and other embodiments can each optionally include one or more of the following features. For example, obtaining a question from a user can include (i) receiving the question from the asking user in a first format in a social search service environment; and (ii) converting the question from the first format to a second format used in the social search service environment. Providing the at least one received answer to the question to the asking user can include (i) converting the at least one received answer to the question from the second format used in the social search service environment to the first format and (ii) sending the at least one received answer to the asking user in the first format.

In general, another aspect of the subject matter described in this specification can be embodied in a computer-implemented method comprising (i) obtaining a question from an asking user; (ii) analyzing the question to determine a set of information associated with the question; (iii) identifying a set of sponsors associated with a bid for at least a portion of the determined information associated with the question; (iv) ranking the set of sponsors based at least in part on a weighted combination of bids by a particular sponsor for at least a portion of the determined information and a projected quality of answer from the particular sponsor; and (v) providing an opportunity to answer the question to at least one of the set of sponsors based on the sponsor's respective rank among the set of sponsors.

These and other embodiments can each optionally include one or more of the following features. For example, obtaining a question from a user can include (i) receiving the question from the asking user in a first format in a social search service environment; and (ii) converting the question from the first format to a second format used in the social search service environment. Providing the at least one received answer to the question to the asking user can include (i) converting the at least one received answer to the question from the second format used in the social search service environment to the first format and (ii) sending the at least one received answer to the asking user in the first format.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a schematic diagram of an example system for enhancing asker and answerer interaction within a social search service environment.

FIG. 2A is a flowchart of an example method for identifying sponsors and receiving answers therefrom in a social search service environment.

FIG. 2B is a flowchart of an example method for ranking two or more potential sponsors prior to providing at least one of the potential sponsors with the opportunity to respond to an analyzed question in a social search service environment.

FIG. 3 is a flowchart of an example method for identifying an operator associated with a sponsor to whom an analyzed question is to be provided in a social search service environment.

FIG. 4 is a flowchart of a first example method for identifying at least one suggested hyperlink for inclusion with a responsive answer by an answerer in a social search service environment.

Like reference numbers and designations in the various drawings indicate like elements.

### DETAILED DESCRIPTION

In general, the present disclosure describes a social search service which allows users, or askers, to tap into the knowledge of individuals, businesses, and other potential answerers within an extended social network. Generally, askers can ask questions in conversational language via the web using an online communication mechanism or channel, including, but not limited to, instant message (IM), email, smartphone, or social networking platforms or applications (i.e., Buzz, Twitter, etc.). The social search service interprets the question and identifies potential answerers who are available and best able to answer the question. The social search service can then contact the potential answerers to determine their interest in responding to or answering the question. If a potential answerer provides an answer, the answer is then forwarded to the asker. The asker then has the ability to respond to the answerer with follow-up or related questions, continue the interactive relationship, or end the interactions. Questions can receive multiple answers from more than one answerer in some instances.

Users of the social search service can update a personal or business profile associated with their user account within the social search service to provide information on the topics and categories for which they are an expert, have additional knowledge on, and/or have interest in answering questions associated therewith. A user's account profile can also include information on previous questions asked and answers answered by the user, the relative quality of those answers, other users' ratings of the user's answers and interactions (including other users' analyses of topics upon which the user has knowledge of or is an expert in), demographic information (including the user's location or areas of service), and other relevant information and data. In instances where the user is associated with a business or other entity, the social search service can allow the user, on behalf of the business or other entity, to bid for the ability to answer certain questions associated with a particular category or topic, for which the user can be able to offer or provide related goods and/or services. The bid value submitted by the user can be considered in combination with the user's category or topic of expertise and the user's previous interactions to assist in determining whether the user will receive the opportunity to respond to a particular question. Additionally, the availability of a particular user, such as whether the user is online in a chat-based or social networking environment, can also be factored into the decision as to which potential answerers will receive a particular question. To provide a real-time answer, the social search service can prefer potential answerers who are available using a real-time messaging application such as instant message (e.g., online and not in the middle of another). Alternatively, answer opportunities can be provided to potential answerers by email or other non-real-time methods.

Additionally, the social search service can take answers received from users, whether from professional or non-professional (or social) answerers, and identify one or more relevant resources, documents, web pages, or other items associated with one or both of the submitted question and the received answer. Prior to returning the answer to the asker, the social search service can prompt the answerer as to whether he or she would like to include one or more of the identified resources. The answerer can select none, some, or all of the suggested resources for inclusion in the answer, where the selected suggested resources can then be embedded within or appended to the answer returned to the asker. The resources can be associated with hyperlinks that can be navigated by the asker. In some instances, the resources can be associated with one or more sponsored links, so that when the asker activates the hyperlink, some type of monetization of the visit can be tracked and charged to the sponsoring party. Similar to the professional answerers, one or more businesses or entities can bid on a particular topic or keyword. When those topics or keywords are associated with a question and/or answer, the sponsored resource (e.g., website, advertisement, hyperlink, etc.) can be suggested by the social search service for inclusion in an answer. In some instances, the sponsored resource can be automatically embedded in or appended to the answer automatically (i.e., without requiring answerer approval). Additionally, the resources can be relevant websites, pages, documents, and other links that can be identified by a search engine through queries based on the submitted question or the responsive answer. The additional resources provide additional information to the asker and create more detailed and helpful questions. By providing the selected resources with the responsive answer, the asker can be more likely to visit the linked documents and web pages for further answers.

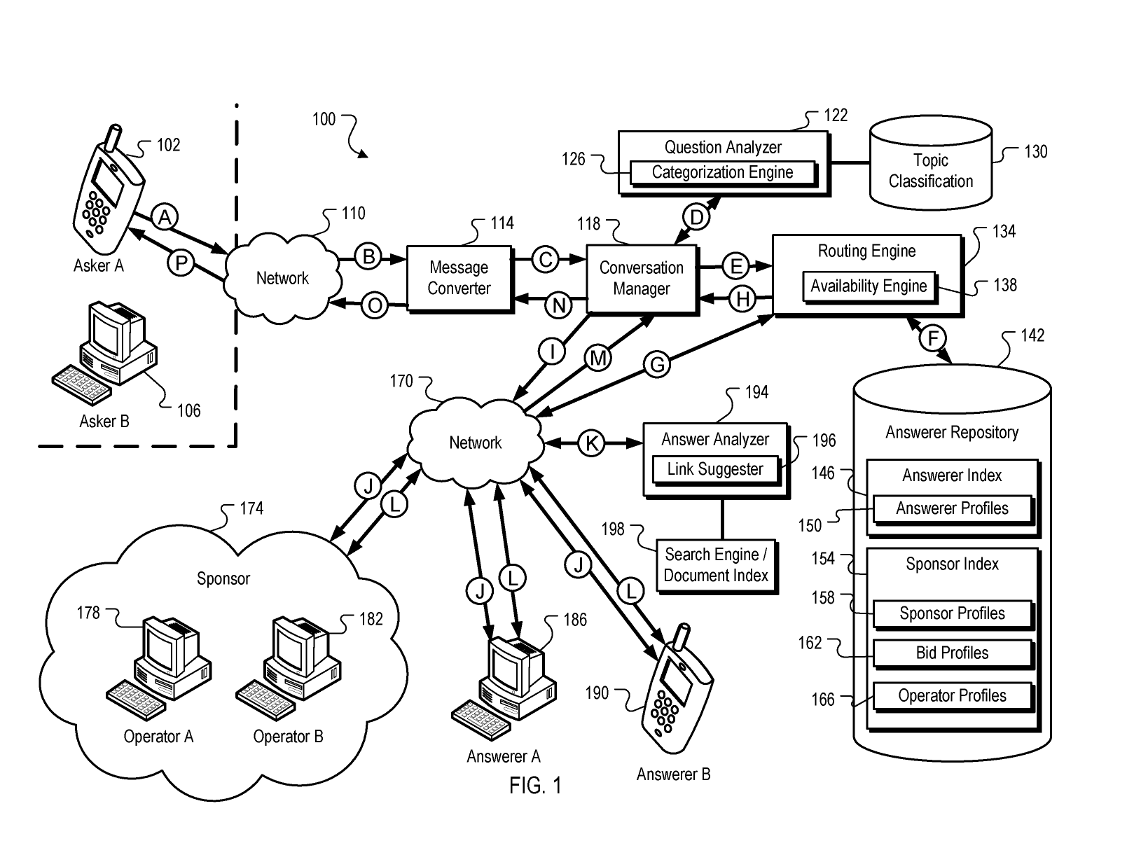

FIG. 1 is a schematic diagram of an example system 100 for enhancing asker and answerer interaction within a social search service environment. In addition to the normal operations of a social search service, the illustrated system 100 includes implementations of both the sponsor answers and user-approved, system-suggested links capabilities described above. The illustrated system 100 includes multiple askers (asker A 102 and asker B 106), multiple answerers (sponsor 174, answerer A 186, and answerer B 190), multiple networks 110 and 170, a message converter 114, a conversation manager 118, a question analyzer 122, a topic classification system 130, a routing engine 134, an answerer repository 142, an answer analyzer 194, and a search engine 198. Communications throughout system 100 can be performed via network 110 or network 170, as appropriate. Additionally, and while not illustrated in FIG. 1, any and/or all of the other illustrated components can also communicate via network 110. The networks 110 and 170 can include one or more local area networks (LANs), a wide area network (WAN), a wireless local area network (WLAN) or WiFi network, a Third Generation (3G) or Fourth Generation (4G) mobile telecommunications network, a wireless cellular network, a private network such as an intranet, a public network such as the Internet, or any combination thereof. Although illustrated as two discontinuous networks, network 110 and network 170 can be a single network, as appropriate, as well as three or more separate networks. In general, the askers (102 and 106) can communicate with the various components of the social search service through network 110, including the conversation manager 118 and the various answerers, to submit and participate in a social search experience.

Each asker can be a user of or associated with any suitable device capable of submitting questions to the social search service system. In various instances, social searches can be submitted via a website, instant message, email, social network application, mobile application or “app,” short message service (SMS) message, or other suitable communication method. The questions can be structured as natural language questions or searches, such that the submitted questions can be similar to a regular spoken question. In some instances, the submitted question can also (or alternatively) include images, audio or video, hyperlinks, or any other type of media or other documents or resources. An asker can be associated with a mobile device, such as a mobile phone, a smart phone, (e.g., SMS-capable device), a tablet computer, a netbook, or a laptop. Still further, askers can be associated with relatively immobile devices, such as a desktop computer or a set-top digital television device, as well as any other suitable type of device. The devices associated with each asker (e.g., 102 or 106) can include graphical user interfaces to allow users to submit questions and view results on or through the devices. In some instances, the devices can receive input from touch gestures using a touch screen, input from a keypad or keyboard, or voice instructions, among others, and can process those inputs to generate a corresponding question for submission via the social search service. The asker can be associated with a user account or profile associated with the social search service environment. Information associated with a user can be anonymized when a question is submitted, as well as when a determination is made as to which users are to be provided a question for answering.

Each device associated with an asker can include a client application that can be used specifically to allow the asker to receive, transmit, and view the data associated with the social search service and/or a particular request. In some instances, the client application can be an application dedicated to searches as described herein, while in other instances, the client application can be a general purpose application (e.g., a web browser, chat program, or email client application) executed on the device associated with the asker for accessing various communication tools and technologies, including those that allow the asker to access web pages and web-based applications, where at least some of those tools and technologies can be associated with submitting questions and viewing responsive answers from the social search service. Alternatively, the device associated with an asker can be an SMS-capable device (e.g., a mobile phone or smartphone), which can send messages to a particular SMS recipient or address associated with a social search service. Additionally, SMS-capable devices can also be capable of submitting requests via methods other than SMS, such as through a mobile web browser or mobile application.

Although illustrated as separate from the sponsor 174 and the other answerers (answerer A 186 and answerer B 190), the askers can also act as answerers in the illustrated system 100. For example, while a particular user can be an asker for purposes of a question on a first topic, that particular user can be an answerer for purposes of questions on a second topic. The social search service can differentiate between the roles when a question is asked, whereas at other times, each asker and answerer is merely considered a user of the social search service until a question is submitted. At that point, the user asking the question is considered an asker, while the other users are considered potential answerers. In those instances, each answerer (sponsor 174, answerer A 186, and answerer B 190), can be associated with a device similar to one of those described along with the description of the askers above. In some instances, a sponsor 174 can be associated with two or more operators. An operator can be any user who answers questions on behalf of the sponsor 174. As illustrated in FIG. 1, the sponsor 174 includes operator A 178 and operator B 182. In some instances, each of the operators can be trained customer service representatives or salespersons capable of providing answers to questions submitted by various askers. In some instances, questions can be routed to a particular operator based on a determination that the sponsor 174 is capable of and/or interested in answering a submitted question and that the particular operator is available in real-time to response to the request. An operator can use a chat or instant messaging client associated with the social search service to respond to questions. Although only two operators are illustrated within sponsor 174, any number of operators can be associated with a sponsor 174, allowing the sponsor 174 to scale the number of operators as needed or desired. Additionally, some or all of the operators for a particular sponsor 174 may not be available to respond to a submitted question at a given time. When determining which answerers to provide a question to at any particular time, the availability of operators associated with a sponsor can be considered as part of the determination.

System 100 includes a plurality of components performing various operations associated with the social search service. Although illustrated separately, some or all of the components can be performed by a single server or computer in some instances. Alternatively, various components of the illustrated system 100 can be performed on dedicated and/or separate servers or systems where appropriate. When a question or query is submitted by an asker to the social search service (arrow A in FIG. 1), the question is provided to the message converter 114 (arrow B, illustrating the receipt of the question via network 110). The message converter 114 can normalize the submitted question into a common format used throughout the social search service. The message can be modified into any suitable format, including an XML-based document through which metadata and additional information (e.g., location information associated with the asker) can be included as the message traverses the system. In some instances, the message converter 114 can include information on the asker who submitted the message within the normalized document, allowing the system to track the question as it traverses the system. Alternatively, a unique ID can be associated with the message, with the relevant information stored in a separate repository. Each component can use the unique ID to identify and add information associated with the message.

The message converter 114 passes the message to the conversation manager 118 (as illustrated by arrow C). The conversation manager 118 performs operations to manage a social search session, including interacting with various other components, to analyze questions (i.e., to identify categories, topics, locations, etc., associated with the question and the asker), identify potential answerers, route questions through the social search service, return answers to askers, suggest resources and links for inclusion in a received answer, manage interactions between askers and answerers, and/or perform other relevant operations. In some instances, the conversation manager 118 can determine that a message received from the message converter 114 is a new question (as opposed to correspondence associated with a previously-asked question). If the message is a new question, the conversation manager 118 sends the question to the question analyzer 122 to determine the appropriate topics and categories associated with the received question, and to return those topics or categorizations to the conversation manager 118 (the interactions illustrated by arrow D).

The question analyzer 122 determines a list of topics associated with each question, each topic representing the semantic subject matter of the question. As opposed to a web search engine, the question analyzer 122 needs only be able to understand the question sufficiently for routing it to a likely answerer. In the social search service, it is the question analyzer 122 that has the responsibility for determining the relevance of a question to a particular answerer. The goal of the question analyzer 122 is, therefore, to classify the topics, categories, and other information (e.g., location-sensitive information) associated with the question so that the conversation manager 118 and routing engine 134 can match the potential topics with the profiles and information associated with potential answerers within the social search network. As illustrated in FIG. 1, the question analyzer 122 includes a categorization engine 126 for performing some or all of the operations associated with analyzing and classifying the received question. The question analyzer 122 and/or the categorization engine 126 can leverage a topic classification system 130, where the topic classification system 130 provides a topic taxonomy for the various classifications available and identified within the social search service. In some instances, the topic classification system 130 can be continuously modified based on system feedback, allowing the social search service to adapt as new topics are identified by users and/or by askers. The question analyzer 122 and categorization engine 126 can perform various analyses of questions to determine the appropriate topics to associate with the question. The question analysis can include one or more of the following:
A non-question determination as to whether the input is not actually a question (e.g., a misdirected message, a sequence of keywords, etc.).
An inappropriate question determination as to whether the input is obscene, commercial spam, or otherwise inappropriate content for a public question and answer community.
A trivial question determination as to whether the input is a simple factual question which can be easily (or better) answered by existing services or search engines (e.g., “What time is it now?”; “What is the weather?”, etc.). If the question is determined to be trivial, the user can be offered an automatically generated answer resulting from a traditional web search.
A location sensitive determination as to whether the input is a question which requires knowledge of a particular location, usually in addition to specific topical knowledge (e.g., “What's a great sushi restaurant in Austin, TX?”). If the question is location sensitive, the question analyzer 122 can pass that information to the conversation manager for use with the routing engine 134.
A keyword match analysis to determine is any terms in the question are string matches with user profile topics.
A taxonomy-based topic analysis to classify the question text based on the associated topic classification system 130 or other topic taxonomy associated with the social search service.
A salient term topic analysis that extracts salient phrases from the question to find semantically similar user topics.
A user tag analysis to determine whether the question includes any tags provided by the asker and a map of those tags to semantically-similar user topics.

The question analyzer 122 and/or categorization engine 126 can use some or all of these analyses and determinations, or others not listed here, to determine one or more topics with which a particular question is associated. Once a list of topics, categories, or locations (or any other relevant information from the question analysis) is identified, the question analyzer 122 returns the results to the conversation manager 118 for further operations.

Once the conversation manager 118 receives the question analysis identified by the question analyzer 122, the conversation manager 118 submits the information associated with the question analysis (e.g., a list of topics) to the routing engine 134 (as illustrated by arrow E) to determine a list and ranking of potential answerers from within the social search service interested in and capable of answering the submitted question. In some instances, only a subset of the question analysis returned by the question analyzer 122, such as the top five topics or categories identified by the question analyzer 122, will be provided to the routing engine 134. In some instances, the conversation manager 118 will also confirm at least a portion of the question analysis with the asker (e.g., the topic assignment), allowing the asker to correct or edit the topic determinations of the question analyzer 122.

The routing engine 134 determines an ordered list of users, or candidate answerers, who should be contacted to answer a particular question, in some instances based in part on the asker of the question and on the topical, categorical, or other contextual information derived by the question analyzer 122. The routing engine 134 can use any number of factors to determine the list of potential answerers. Examples of the determining factors can include one or more of the following:
Topic Expertise: The routing engine 134 can determine the subset of users who are semantic matches to the question—users whose profiles indicate expertise relevant to the topics identified for the question. Users whose profiles are closer to the question's topics are given a higher rank. For questions that are location-sensitive, potential answerers with matching or nearby locations in their profiles are considered.
Connectedness: The routing engine 134 can score each user (or potential answerer) according to the degree of connection the potential answerer is for the asker. The goal of this scoring can be to optimize the degree of kinship and trust between the asker and answerer, arising from their sense of connection and similarity, and meet each other's expectations for conversational behavior in their interactions. In some instances, a social graph can be used to identify relationships and affiliations of users within the social search service. In some instances, this information can be based on relationships created through previous interactions between users within the social search service or similar information included in a particular user profile (e.g., real-world affiliations, such as schools attended, companies worked at, location, etc.), while in other instances the information can be imported from one or more other locations (e.g., a social networking site, email importations, instant messaging friends, etc.).
Availability: The routing engine 134 can prioritize potential answerers to optimize the possibilities that a particular question will be answered soonest. For example, the availability determination can be made based on whether a potential answerer is available in real-time or near real-time, such as by prioritizing users who are currently online (e.g., via instant messaging, chat programs, currently on related mobile applications, etc.), who are historically active at the present time-of-day, as well as who have not been contacted recently with a request to answer a question. With regard to the online/offline determination, an availability engine 138 can be used by the routing engine 134 to determine, via network 110 or network 170, whether a potential answerer is currently available to receive and answer a question for which they are suited (as illustrated by arrow G in FIG. 1).
Policy Restrictions: The social search service can be associated with various policy limitations and restrictions for contacting potential answerers. For example, the social search service may have a policy to limit the number of times a user can be provided a question to ensure the user is not contacted too often. Additionally, user-level policies can provide information on how often a particular user is willing to be contacted with a question. The user policies and general service-level policies can assist in the determination of appropriate potential answerers for a particular question.

Additional criteria and determinations can be made to identify the most appropriate potential answerers for a particular question. After combining the information, the routing engine 134 can determine which potential answerers are best suited to be asked the question. The list of potential answerers can be returned to the conversation manager 118 (as illustrated by arrow H).

In some instances, and as illustrated in FIG. 1, the routing engine 134 accesses the answerer repository 142 that includes information on normal, or social answerers, and/or sponsors providing professional answers associated with the system 100 (as illustrated by arrow F). The answerer repository 142 can be a single repository, or can be a plurality of remotely accessible repositories. As illustrated, the answerer repository 142 includes an index for non-professional, or normal, answerers 146 and a sponsor index 154. The answerer index 146 can include a set of answerer profiles 150, which can also be called user profiles. The answerer profiles 150 can be generated for each user, including information on the relationships between individual users, the topics with which a particular user is an expert or interested in answering questions for, information or metrics on previous interactions and answers provided by the user, and demographic (including location-related information) and other information associated with the user, including the methods through which the user can be contacted to receive questions.

The sponsor index 154 includes additional information on businesses and other entities who have bid on the opportunity to answer particular questions or questions associated with a particular topic, category, keyword, or other identifiable domain of questions. A sponsor providing professional answers can be analogous to a sponsored advertiser in a web search. In the social search context, however, the sponsor bids are not for the ability to have sponsored search results presented in a search results page, but rather to answer a question and interact with an asker who has submitted the question via the social search service. As illustrated in FIG. 1, each sponsor in the sponsor index 154 can be associated with at least three sets of information: a sponsor profile 158 (similar to the normal answerer profile 150 of the answerer index 146), a bid profile 162, and a set of operator profiles 166. The sponsor profile 158 can define various types of information associated with the sponsor, including demographic information associated with the sponsor, including the sponsor's self-reported or community-identified expertise and domains of interest (including specific topics within the overall domain of interest or expertise), its location(s) or regional associations, and the goods and services offered by the sponsor, among others. Additionally, the sponsor profile 158 can store or reference information on the previous interactions and answers provided within the social search service. All of the information contained within the sponsor profile 158 can be analyzed so that ratings for particular topics and expertise can be generated.

The bid profile 162 for a particular sponsor can store information on the topics, categories, and domains for which the particular sponsor wants to receive and answer questions from askers within the system. For example, a company involved in vetting and identifying plumbing and other household contractors for customers can bid on certain topics to receive questions with home repair-related topics. Other sponsors can also bid for the same topics in some instances, such that overlapping bids may exist. In determining which of the sponsors to provide the question, the bid values can be combined in an analysis with the corresponding sponsor profiles 158. In other words, the potential quality of the answer is weighted a first amount in the analysis, while the specific bid for the relevant topic is weighted a second amount. Based on that analysis, the higher ranked sponsor can be provided the first attempt at answering the question from the asker. Bid values can be placed on any types of interaction with the asker, including from simply receiving the question to actual business generation based on the answer provided by the sponsor. The bids from different sponsors can be normalized and compared where the bid types differ. In some instances, only one sponsor may have submitted a bid on a particular topic, while in other instances, three or more sponsors may have submitted bids on a particular topic. Additionally, bids placed on a first topic can also be considered in other, semantically-related, topics, allowing one bid to cover related topics, as well. In some instances, bids based on semantically-related topics can be provided less weight than specific bids for a particular topic.

The sponsor index 154 also includes operator profiles 166 associated with each of the sponsors. Each operator profile can describe a particular employee or representative associated with a sponsor in a manner similar to the answerer profile. Multiple operator profiles can be associated with a single sponsor. Further, each operator profile can describe the various means of communication through which a particular operator can be contacted (e.g., instant message screen name, chat screen name, email address, etc.), as well as the specific hours a particular operator is available (e.g., working hours). The routing engine 134, and specifically, the availability engine 138, can use the information in the operator profiles 166 to determine whether a particular operator is available in real-time, or via a real-time messaging application or platform, to answer a particular question. The availability of particular operators can factor (heavily, in some instances) into the decision on which sponsor to provide a question. For example, if a first sponsor has several available operators, while a second sponsor has none, a close ranking between the first and second sponsor can be decided in favor of the first sponsor due to the availability of operators to respond to the question and interact with the asker. To provide a real-time or near real-time answer, the availability of operators can be weighted heavily in the algorithms for determining which sponsor to supply the question.

After searching through the answerer repository 142, the routing engine 134 can return a ranked list of potential answerers to the conversation manager 118 (as illustrated by arrow H). The conversation manager 118 can then send the identified answerers the questions for responses. The conversation manager 118 uses the contact information from the answerer index 146 and/or the sponsor index 154 to determine how to contact the identified answerers. In FIG. 1, the conversation manager 118 relays the questions to the appropriate answerers via network 170 (as illustrated by arrow I), which then provides the questions to the appropriate answerers (as illustrated by arrows J). In some instances, the conversation manager 118 can send the questions to identified answerers sequentially as listed in the ranked list of potential answerers, determining whether the top-ranked potential answerer would like to answer the question. If not, the conversation manager 118 can then send the question to the next highest-ranked potential answerer, until a satisfactory response is received.

The answerer (or operator associated with a particular sponsor) receives the question and can prepare a response. In some instances, questions may not be provided to sponsors (e.g., due to asker preferences or declining professional answers, because no topic or keyword matched or was associated with the analyzed question, etc.). In those instances, the question is routed to a normal answerer who can provide an answer based on their personal expertise. When a question is routed to a sponsor, the question can be addressed to a particular operator of that sponsor. Alternatively, the question can be sent generally to the sponsor. The sponsor can itself have a computer system or other software capable of routing the question to an available or best-suited operator for response. Alternatively, the question can be available for all operators, who can select a received question to which to provide an answer. In some instances, an operator associated with a particular sponsor can refer a received question to another operator associated with the same particular sponsor. Any suitable methods of providing the question to an operator can be used herein.

Once an answer is completed, the answerer can submit the response to the question (as also illustrated by arrows J). In some instances, however, the social search service can provide functionality for suggesting and incorporating additional references and/or hyperlinks into the answers submitted by the answerers prior to returning those answers to the asker. As illustrated in FIG. 1, when an answer is submitted by an answerer, the answer can be routed to the answer analyzer 194 (as illustrated by arrow K). In some instances, this routing can occur prior to forwarding the submitted answer to the conversation manager 118, while in others, the conversation manager 118 can determine and control when answers are routed to the answer analyzer 194. In either event, the answer analyzer 194 can be used to identify, based on one or both of the questions asked or the answer submitted, additional related material, references, web pages, or other information. In some instances, the answer analyzer 194 can include a link suggester engine 196, where the link suggester engine 196 (and the answer analyzer 194) can analyze the question and/or the answer to determine additional information to suggest to the answerer for inclusion in the answer returned to the asker. The link suggester engine 196 can be associated with a web search engine 198 (or document index) to identify one or more hyperlinks to documents and/or relevant references associated with the question or answer. In some instances, the answer analyzer 194 can parse the question and/or the answer to determine keywords and/or query terms that should be searched or considered for additional materials. The results of the parsing can then be submitted to the search engine 198 or document index for the identification of one or more potential resources or documents. In some instances, the answer analyzer 194 and link suggester engine 196 can be associated with a keyword-based advertising system, such that links can be based on sponsored content (not necessarily associated with the sponsors described herein).

The answer analyzer 194 can then return or provide a prompt to the user with the set of suggested links back to the answerer who submitted the answer to the question (as illustrated by arrows K and L of FIG. 1). The answerer can be contacted by the same methods as used to answer and submit the question, although alternative methods of communication can also be used. The answerer can review the system-suggested links. If the answerer determines that one or more of the system-suggested links are relevant to the question and answer, the answerer can select a subset of the suggested links for inclusion with the submitted answer (e.g., by embedding or appending the selected links with the submitted answer). The answerer can also determine that none of the links should be included in the answer, such that the answer can remain unchanged from its initial submission. Once the one or more links are selected (or no links are selected), the answerer finalizes the answer and submits the answer, along with the answerer-selected suggested links, back to the conversation manager 118 (as illustrated by arrows L and M). In some instances, the answer can be provided to the conversation manager 118 separately from the selected links. In some instances, the answer and selected links can be combined into a merged answer, so that the selected links are integrated into or associated with the submitted answer. In some instances, the submitted answer can be provided back to the asker in a first message or communication, while the user-selected links can be provided to the asker in a second message or communication.

The conversation manager 118 then sends the combined answer (or where no links are selected, the submitted answer) to the message converter 114 (as illustrated by arrow N). The message converter 114 can the modify the received answer into the appropriate structure and/or format associated with the corresponding asker (in some instances, the same format through which the original question was received). The message converter 114 can then relay the converted message (via network 110 and as illustrated by arrow O) to the originating asker (as illustrated by arrow P). The asker can then receive the answer to the submitted question, along with any answerer-approved and system-suggested links identified in association with the answer analyzer 194. If the asker is not satisfied with the answer, the asker can request an additional answer from the social search service. In those instances, the conversation manager 118 can submit the question to the next highest-ranked potential answerer, continuing its operations. If the asker is satisfied with the answer, the asker can initiate further interactions, such as follow-up questions or conversations, with the answerer. If the answerer is a sponsor capable of providing goods or services associated with the question, the asker and sponsor answerer can be able to work together to initiate a business relationship.

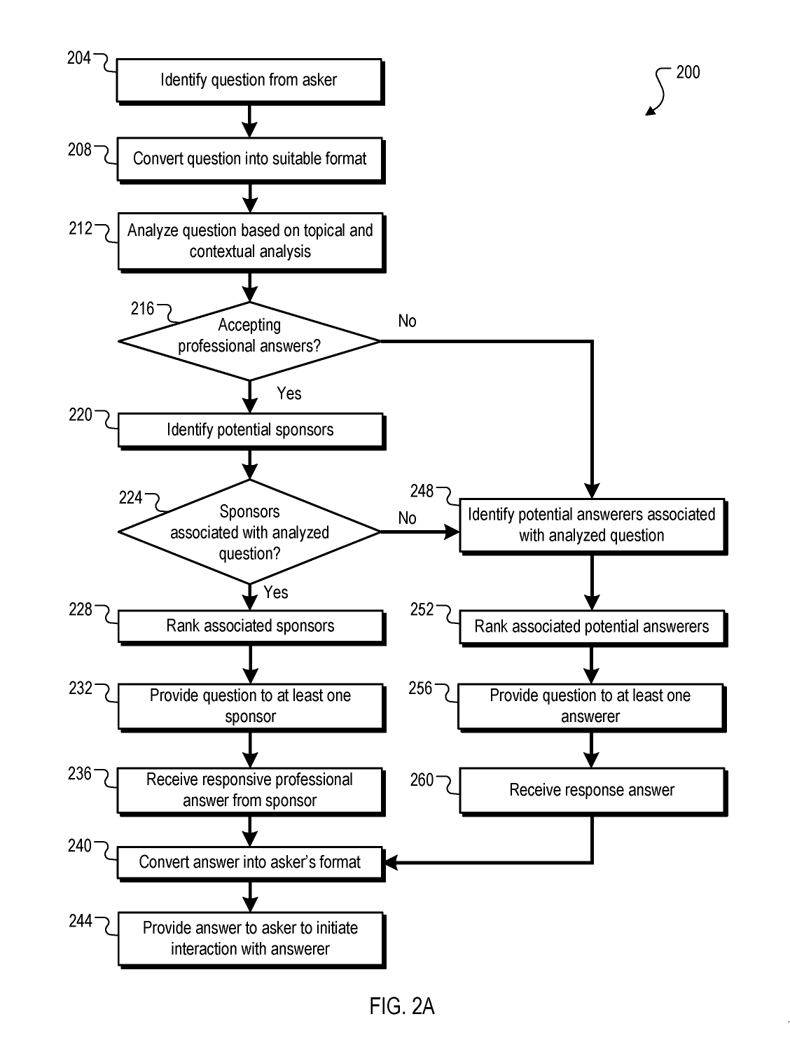

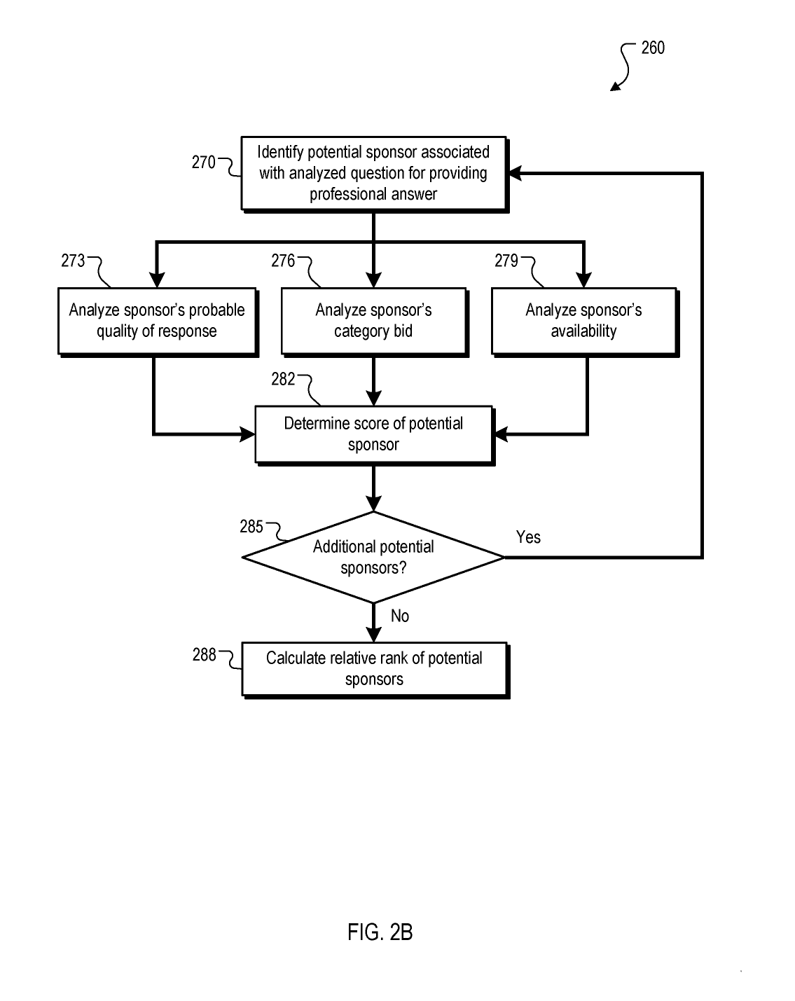

FIG. 2A is a flowchart of an example method 200 for identifying sponsors and receiving answers therefrom in a social search service environment. For clarity of presentation, the description that follows generally describes method 200 in the context of system 100 illustrated in FIG. 1. However, it will be understood that method 200 can be performed, for example, by another system, environment, or combination of systems and environments.

At 204, a question from an asker is identified. Identifying the question can include receiving the question directly from the asker, such as at a specified location associated with a social search service (e.g., an instant messaging address, a chat address, a web site, a social networking page, etc.). At 208, the identified question is converted into a suitable format for further processing. In some instances, the conversion can include modifying the question from a first format in which the question was received into a second, normalized format through which the question can be analyzed and operated on in the social search service environment. The converted format can be a well-known format, such as an XML document, or it can be a format unique to or modified specifically for the social search service.

At 212, the question is analyzed based on a topical and, in some cases, contextual analysis (including a location-related analysis of the question and, optionally, the asker). The analysis of the question can be performed by a question analyzer. In some instances, the question can be analyzed based on a plurality of factors, including (a) determining whether the question is location sensitive or is location-relevant, (b) determining one or more key words or phrases included in the question, (c) determining one or more topics related to, but not included in, the key words or phrases identified within the question, (d) identifying any asker-provided tags included within or associated with the question, (e) comparing the information in the question with a classification taxonomy defining a plurality of topics, (f) associating the question with one or more identifiable traits or other information associated with the submitting asker, or any other type of categorization. Once the question is analyzed, the results of the question analysis can be included within the normalized format of the question itself or by association with a unique question identifier accessible throughout the social search service environment.

At 216, a determination is made as to whether the asker is willing to accept professional, or sponsored answers, to the identified question. In some instances, a user profile associated with the asker can store information determining whether the asker has agreed to receive professional answers. If the asker is willing to receive professional answers, method 200 can continue at 220. Alternatively, but not illustrated in FIG. 2A, method 200 can initially provide a non-professional answer to the asker. After the non-professional answer is provided to the asker (via the illustrated loop from 248-260), the asker can be queried as to whether he or she would be interested in receiving a professional answer to the question. If so, method 200 can return to 220 where the operations associated with providing a professional answer are performed. In some implementations, all answers can initially receive a normal (i.e., non-professional) answer from a normal answerer. In other implementations, the asker's preferences or selections can choose to initially provide a professional answer, if available. If it is determined that the asker is not accepting professional answers, method 200 continues at 248.

At 220, a set of potential sponsors is identified. In some instances, identifying potential sponsors can include comparing the topics, categories, or other information associated with the submitted question and its analysis (at 212) with a set of sponsor information. The set of sponsor information can include bid information for which one or more sponsors have submitted bids for the right to answer questions associated with a particular topic, category, or domain of interest or expertise. Additionally, key words included in the question, along with asker-specific information, can be compared to the bids provided by potential sponsors. At 224, a determination is made as to whether sponsors associated with the analyzed question (and the results of its question analysis) are identified. In some instances, a particular topic, category, or domain may not be associated with any sponsors. In those instances, method 200 continues at 248. If, however, at least one sponsor is identified at 220, method 200 continues at 228.

At 228, the identified potential sponsors are ranked based on one or more criteria. In a simple analysis, the bid submitted by an identified potential sponsor is combined in a weighted analysis with information on how likely the identified potential sponsor's answer will be of assistance to the asker. Alternatively, the bid alone can be considered. In still other instances, additional information, including the availability of a potential sponsor (or operator associated with the potential sponsor) to respond in real-time (e.g., via a real-time messaging system), can be considered in ranking the identified potential sponsors. Additional details on ranking potential sponsors are described below in association with FIG. 2B.

At 232, the question is provided or transmitted to at least one of the potential sponsors. In some instances, the question can initially be sent only to the relatively highest-ranking sponsor from 228. That sponsor can choose to answer the question, or can elect to pass and not answer the question. Alternatively, if that sponsor does not respond to the question after a certain period of time, the sponsor may be deemed to have passed on answering the question. In some instances, a queue of questions potentially routed to a particular sponsor can be maintained (in some cases, until an answer for a particular question is received from another sponsor or other answerer). If the highest-ranking sponsor declines to answer, the next highest-ranking sponsor from the ranking of 228 can be sent the question. Alternatively, two or more of the sponsors can be initially sent the question for answering. The determination of how many sponsors can receive the question can be based on any suitable criteria, including by asker request, when no single sponsor is ranked statistically significantly higher than the one or more other sponsors, or based on the social search service settings, among others.

At 236, a responsive professional answer is received from at least one of the sponsors to whom the question was sent in 232. At 240, the responsive answer can be converted into the appropriate message format for the asker. In some instances, the format in which the responsive answer is returned to the asker can be the same as the format in which the question was submitted. For example, an asker interacting with a social search engine via an instant messaging client can submit a question and receive an answer through an instant messaging client. Alternatively, the format in which the question was initially submitted can be different than the format in which the responsive answer is to be returned. For example, a question can be submitted through an SMS message, and responses to the question can be returned via a responsive SMS message, or through a mobile client application associated with the social search service (and notifying the asker through a push notification). In some instances, the asker can submit a question in a plurality of manners, but can specify a particular means for receiving the responsive answer or answers (e.g., through email). The information determining the format in which the response is to be provided can be the asker's profile, information associated with the question, or a dynamic determination at runtime based upon the asker's real-time availability through the communication channel by which the initial question was submitted (i.e., whether the user is online or offline an instant messaging platform—if the asker is no longer available, the responsive answer can be provided by email). At 244, the responsive answer (in the appropriate format) is returned to the asker. The asker and answerer can initiate interaction with one another through continued messaging and follow-ups, allowing the sponsor to potentially provide goods and services to the asker based on the professional answer.

In instances where either no professional answers are being accepted (“no” from 216) or where no sponsors are available (“no” from 224), method 200 continues at 248 and identifies one or more potential normal answerers associated with the analyzed question, or the identified topics, locations or other information associated with the analyzed question. In some instances, the potential answerers can be filtered based on a location-sensitive question, such as a question specific to a particular city or area. Additionally, potential answerers can be filtered based on underlying social networking relationships between users, such as “friends” or other types of related users. At 252, the potential answerers identified in 248 are ranked. Ranking the potential answerers can be similar to the ranking function described for 228, except without a consideration of any bid associated with the topic. The ranking can also consider the availability of the potential sponsors to respond to the question, either based on an actual determination of availability, on the times previous answers have been provided by the potential answerer, or on times specified by the potential answerer for receiving questions. At 256, at least one of the potential answerers is provided the question for an opportunity to respond (usually based on the ranking of 252), and at 260 a responsive answer is received from the at least one potential answerer. Method 200 then continues at 240 and 244 to convert the responsive answer into the appropriate format and provide that answer to the asker.

As described in connection with method 200 of FIG. 2A, in some implementations, each question can receive a normal (or non-professional) answer first (using the algorithm defined by 248-260). After the non-professional answer is received, the asker can be queried as to whether they would be interested in a professional answer. If the asker agrees to receive a professional answer, then operations associated with 216 through 236 can be performed. In some instances, the asker can be more comfortable receiving a professional answer after receiving a similar or related response from a normal answerer. By providing professional answers after a normal answer is received, the asker can be more willing to participate or engage with a sponsor, thus leading to a higher percentage of business interactions resulting from the question and answer interaction. Additionally, a user's profile can be dynamically updated over time as professional answers are accepted to occasionally allow a professional answer to be initially returned when a question is submitted by that user.

FIG. 2B is a flowchart of an example method 260 for ranking two or more potential sponsors prior to providing at least one of the potential sponsors with the opportunity to respond to an analyzed question in a social search service environment. For clarity of presentation, the description that follows generally describes method 260 in the context of system 100 illustrated in FIG. 1. However, it will be understood that method 260 can be performed, for example, by another system, environment, or combination of systems and environments.

At 270, a potential sponsor associated with an analyzed question is identified. The potential sponsor can be identified based on bids the sponsor has placed on a particular topic or keyword associated with the question. In some instances, the topic or keyword for which the bid was placed may not be identical to those included in the question or the topic/category associated with the question as determined by a question analysis, but can instead be related to the topic or keyword associated with the question.

In the present implementation, several analyses contribute to the relative ranking of each sponsor. The analyses illustrated in FIG. 2B include (a) an analysis of a particular sponsor's probable or predicted quality for its response (273), (b) an analysis of the sponsor's bid for the topic, category, location or keyword associated with the question (276), and (c) an analysis of the sponsor's availability to answer the question (279). Although not illustrated in FIG. 2B, additional analyses may include consideration of a service-level or user policy restrictions, such as how often the sponsor can receive a question, and a budget-based analysis determining whether a predefined amount of available spending (per day, month, etc.) for a particular sponsor has been exceeded or how the amount has been used. Returning to FIG. 2B, the analysis of the particular sponsor's probable or predicted quality for its response of 273 can be based on several factors, including information and feedback associated with previous answers provided within the social search service by the sponsor. Additionally, the topical or domain of expertise of the sponsor, which can include the topics and domains for which the sponsor has identified itself as an expert, and those in which other users identify that the sponsor is knowledgeable, can be considered. In some instances, the number of previous successful interactions with askers, including the number of conversions of conversations into business, can be considered, as well. Additionally, the number of times a sponsor has declined questions for a particular topic or category can be considered, as well as any positive or negative feedback associated with the sponsor.

The analysis of the sponsor's bid for the topic, category, or keyword(s) associated with the analyzed question can also be considered. The bidding can be placed for various types of interaction within the system. For example, a bid can be submitted for the opportunity to answer a question, for actually answering a question, or for converting the responsive answer into business with the asker after the answer is provided to the asker. In some instances, the bids can be multi-tiered, so that the sponsor is willing to pay different amounts for the various interactions associated with a particular question. Alternatively, bids can be limited to one or a subset of events and interactions. Various algorithms can be used to normalize the different types of bids to calculate the relative bid amount.

The analysis of the sponsor's availability to answer the question can be considered within the algorithm for determining the relative ranking of potential sponsors. In some instances, a determination can be made as to whether one or more operators associated with the potential sponsor are available to receive and respond to a question in real-time (i.e., via instant messenger, chat, or otherwise). In some instances, the social search service can allow operators associated with sponsors to log into and out of the system to clearly identify when the operators are available. Alternatively, the social search service can dynamically determine the availability of operators, including by determining whether the operator is currently involved in an interaction with another asker. In some instances, the average time to provide a response for a sponsor can be used to determine the availability, as well as the normal times during the day that the sponsor (or its operators) respond to presented questions.

At 282, the weighted values of the illustrated analyses are combined in a weighted analysis to determine a score of the potential sponsor. In some instances, such as where a question is determined to require more expertise to answer than normal, the weighting of the various factors can be modified. For example, a question related to science or mathematics can weigh the expertise and likely quality of an answer higher than the availability of the answerer. Similarly, a question regarding a pop culture topic can weigh a potential sponsor's availability more heavily than the probable quality of the answer itself. Different topics can be associated with different weighting factors, and in fact, can include additional analyses and calculations in determining a particular score. In some instances, the asker can specify a preference for speed over probably quality or vice versa, which can modify the weighting of the criteria.

Once the score of a potential sponsor is calculated, a determination is made at 285 as to whether any additional potential sponsors have been identified. If so, method 260 returns to 270 to calculate a score for the next potential sponsor. If no additional potential sponsors are identified, method 260 concludes at 288, where the determined scores of the various potential sponsors are compared to calculate a relative ranking of the various answerers. It will be understood that, in some instances, the analysis of each potential sponsor may be performed concurrently or during overlapping periods.

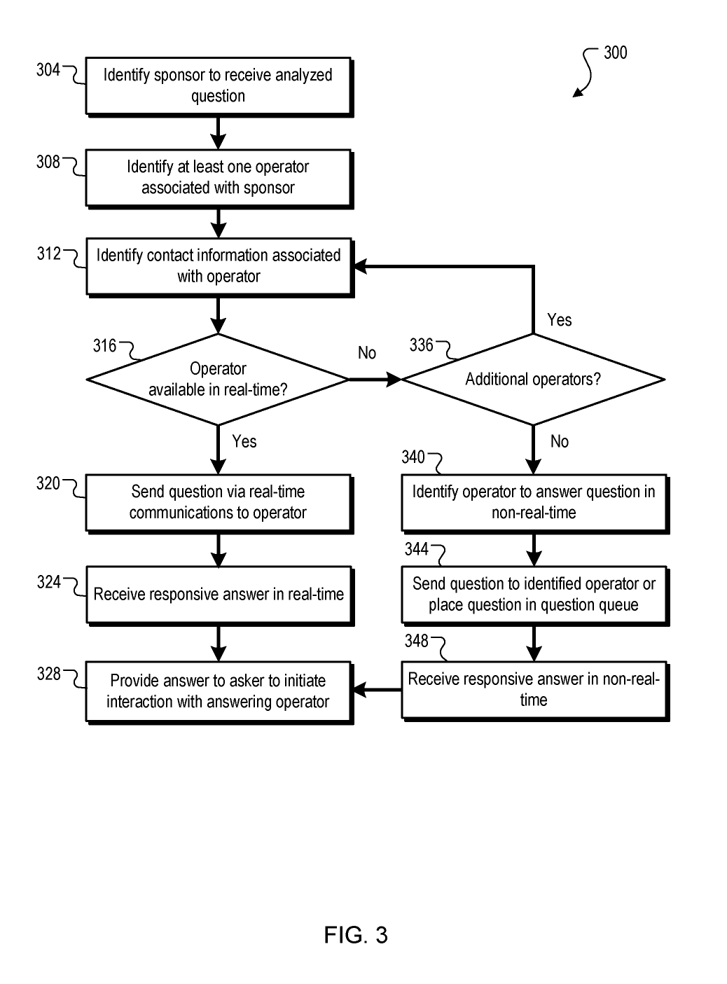

FIG. 3 is a flowchart of an example method 300 for identifying an operator associated with a sponsor to whom an analyzed question is to be provided in a social search service environment. For clarity of presentation, the description that follows generally describes method 300 in the context of system 100 illustrated in FIG. 1. However, it will be understood that method 300 can be performed, for example, by another system, environment, or combination of systems and environments.

At 304, a sponsor for receiving an analyzed question is identified. Additionally, portions of method 300 can be used when calculating the availability of a potential sponsor while still determining which sponsor will receive the question. In the illustrated example, however, it is assumed that the sponsor has been selected to receive the question.

At 308, at least one operator associated with the sponsor is identified. The operators associated with a particular sponsor can be identified based on information in a sponsor-specific profile, such as the operator profiles 166 illustrated in FIG. 1. At 312, the contact information associated with a first operator is identified. The contact information can include a unique address or channel associated with the particular operator (e.g., a specific instant messaging user name, an email address, a social networking page, etc.), or a general sponsor contact channel through which the particular operator can be reached. In some instances, the first operator identified can be identified as the primary responder in the sponsor profile, while in other instances, different operators can be associated with different expertise, domains, topics, or locations for the sponsor.

At 316, a determination is made as to whether the first identified operator is available in real-time (or near real-time). The determination of 316 can be made by determining if the first identified operator is available via an instant messaging or chat platform associated with the social search service (e.g., online and not in another interaction). Alternatively, each operator can have certain times at which the operator is assumed to be available. If the operator is determined to be available in real-time, then method 300 continues at 320. If, however, the operator is not determined to be available in real-time (or near real-time), method 300 continues at 336. At 336, a determination is made as to whether there are any other additional operators associated with the sponsor. If there are, method 300 returns to 312 to identify one of those additional operators' contact information and continues at 316 to determine whether the operator is available in real-time. In some instances, the determinations as to availability for a particular operator may include detecting the operator's current or recent activity, current idle time, or other informaiton relevant to availability. This process can continue until an operator available in real-time is identified, or until there are no additional operators associated with the sponsor. If no operators are available in real-time, the first operator (or any of the other operators) is contacted at 340.

Returning to 316, if an operator is identified as available in real-time, method 300 continues at 320. At 320, the question from the asker is sent via real-time communications to the operator (e.g., via instant message, chat client, or other real-time or near-real-time communications). In some instances, and not illustrated in FIG. 3, the receiving operator can refer the received question to another operator associated with the sponsor. For example, the referral can be based on the relative expertise or availability of different operators associated with the sponsor. At 324, a responsive answer from the identified operator is received, which can then be provided to the asker to initiate further interaction between the operator and the asker at 328. The operator can provide the answer and follow up on any questions the asker can have. Additionally, the operator can provide an offer for goods or services associated with the question and answer to the asker, possibly initiating a business relationship between the parties.

Returning to 336, if the determination is made that no operators are available for real-time correspondence and answers in the social search service, method 300 continues at 340. At 340, one of the operators associated with the sponsor is identified to receive and answer the question through a non-real-time channel. The particular operator identified can be based on any number of factors, including the particular operator's expertise, relative availability (e.g., working hours), or any other suitable criteria, including the relative quality of responses received from one operator as compared to another operator also associated with the sponsor. Once the operator is identified, the question is sent to the operator through the non-real-time channel, such as email, at 344. Alternative methods of transmission can include posting to a social networking page (e.g., Buzz or Twitter), to a really simple syndication (RSS) page, or any other suitable channel. In some instances, the question can be placed into an operator- or sponsor-specific queue where questions awaiting answering can be stored and accessed at later times by the associated operator. At 348, a responsive answer is received from the operator, which can then be provided to the asker at 328. In some instances, even though the operator was not initially available to participate in the social search in real-time, the operator and asker can initiate a real-time or non-real-time set of interactions to engage in further discussions and a potential business relationship after the answer is received. In some instances, an instant messaging instance can be initiated between the answering operator and the asker, allowing the two parties to begin a real-time conversation and interaction after the answer has been submitted.

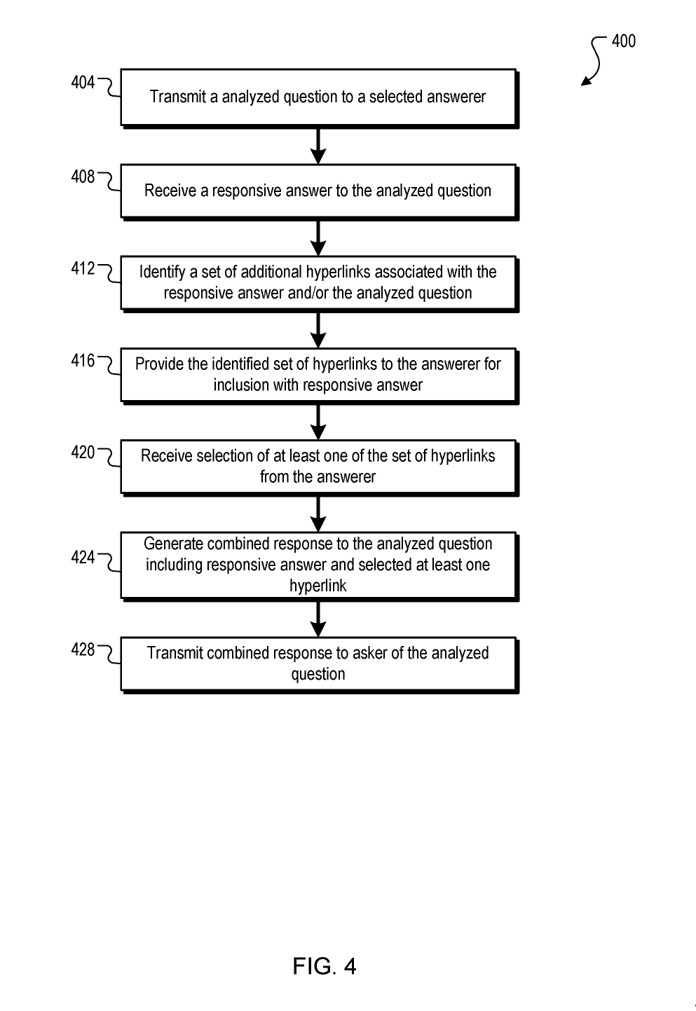

FIG. 4 is a flowchart of a first example method 400 for identifying at least one suggested hyperlink for inclusion with a responsive answer by an answerer in a social search service environment. For clarity of presentation, the description that follows generally describes method 400 in the context of system 100 illustrated in FIG. 1. However, it will be understood that method 400 can be performed, for example, by another system, environment, or combination of systems and environments. Further, method 400 can be performed whether or not the answerer is considered a sponsor, and can be optionally performed for each answer received through the social search service.

At 404, an analyzed question is transmitted to a selected answerer. As stated above, the selected answerer can be a sponsor (or operator associated with a sponsor) or a normal answerer. At 408, a responsive answer to the analyzed question is received from the selected answerer. At 412, a set of additional references or links associated with the responsive answer and/or the original analyzed question can be identified. In some instances, the answer or question can be parsed by an answer analyzer to identify one or more keywords and phrases. In some instances, the keywords can then be compared to a document index or submitted to a web search engine associated with the social search service to identify additional information associated with the question or answer that can be of interest and related to the question and answer interaction. In some instances, advertisers can be associated with particular keywords or phrases associated with either the responsive answer or the original question, with those advertisers' web pages or related links being returned in 412. In responses where a particular company, person, entity, or location is mentioned, links to additional information on the mentioned company, person, entity, or location can be provided. For example, if the original question asked for a recommendation for a new book to read, and the responsive answer included the name of a particular book, the additional information identified in 412 can include a hyperlink to a web page or website where the asker can purchase the book or read additional reviews, such as at a retailer website like Amazon.com.

At 416, the set of additional identified hyperlinks or references are provided to the selected answerer. The selected answerer is then able to select one or more of the additional hyperlinks to include in the responsive answer. The selected answerer can review the suggested hyperlinks to determine if the material associated with the hyperlink is relevant to the responsive answer. The hyperlinks can be selected by the answerer, for example, by activating checkboxes associated with each hyperlink presented in a pop-up window or other UI element.

At 420, a selection of at least one of the set of hyperlinks is received from the selected answerer. Alternatively, and not illustrated in FIG. 4, none of the hyperlinks may be selected, wherein method 400 can continue at 428 and transmit the original responsive answer, without additional hyperlinks, to the asker. In some instances (also not shown in FIG. 4), if no selection of the hyperlinks is received within a predetermined period of time, a determination can be made that none of the hyperlinks are to be selected. The selection can be considered to have timed out, and method 400 can continue at 428 where the responsive answer is transmitted, without additional hyperlinks, to the asker.

At 424, a combined response to the analyzed question is generated that includes and integrates the responsive answer (received at 408) and the at least one suggested hyperlink as selected by the answerer. In some instances, the integration of the answer and selected hyperlinks can be done so that the combined response represents a seamless, or transparent, integration of the two, such that the asker reviewing the combined response can not be able to determine that the answer and links were provided by two different operations. In some instances, the combined response can be two separate messages or communications. At 428, the combined response is transmitted to the asker for review and consideration.

The hyperlinks included in the combined answer represent resources that have been vetted by the answerer, indicating to the asker that the hyperlinks are of value for review. Because of the inherent trust generated by the social search service paradigm, the click-through rates associated with those hyperlinks are likely to be higher than those associated with a set of search results from a web search engine. Additionally, the hyperlinks and resources the hyperlinks represent can comprise additional information supporting the responsive answer. In some instances, the suggested links can be of interest to the selected answerer and the asker, thereby providing two instances of potential monetization for relevant sponsored results. In some instances, the initial response received from the selected answerer can be sent to the asker after 408. Instead of integrating the suggested links into a combined answer, the suggested links can be sent separately from the answer as a follow-up or additional response (e.g., via email). Further, in some instances, one or more of the hyperlinks and/or resources identified in 412 can be automatically added to a responsive answer without requiring the answerer's selection. For example, where an address is included in a responsive answer, a hyperlink to a map (or the map itself) can be added to the responsive answer when a high probability exists that the map is associated with the responsive answer. In general, the effect of the suggested hyperlinks allows the system to leverage the social experience and communication dynamics within the social search service by incorporating portions of the traditional web search paradigm into the social search service. The suggested hyperlink solution allows the answerer to evaluate the results of the traditional web search prior to providing them back to the asker, providing the answerer with the ability to truly recommend hyperlinks and resources returned from the web search application.

While the present disclosure uses a plurality of flowcharts and accompanying descriptions to illustrate the example techniques associated with various methods of FIGS. 2A-4B, system 100 contemplates using or implementing any suitable technique or method for performing these and other tasks. It will be understood that these techniques are for illustration purposes only and that the described or similar techniques can be performed at any appropriate time, including concurrently, individually, or in combination. In addition, many of the steps in these flowcharts can take place simultaneously, concurrently, and/or in different orders than as shown and described. Moreover, system 100 can use processes and methods with additional, fewer, and/or different steps, so long as the processes and methods remain appropriate.

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on computer storage medium for execution by, or to control the operation of, data processing apparatus. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them, where some or more can be non-transitory. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices). In some instances, the computer readable medium can be a non-transitory and/or tangible computer readable medium.

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, application, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program can, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server. Further, the computing system can include actions performed via a cloud-based computing system implementing a cloud architecture. A cloud architecture can include multiple cloud components communicating with each other through application programming interfaces (APIs), such as web services. A front end of the system can be presented to clients, and can include the client's network or computer, as well as the applications used to access the cloud-based computing system, such as a web browser. The back end of the cloud-based computing system can include various different computers, servers, and data storage devices performing the operations associated with the system.

While this specification contains many specific implementation details, these should not be construed as limitations on the scope of what can be claimed, but rather as descriptions of features specific to particular embodiments of particular implementations. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features can be described above as acting in certain combinations and even initially claimed as such, one or more features from a claimed combination can in some cases be excised from the combination, and the claimed combination can be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing can be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1-39. (canceled)

40. A computer-implemented method comprising:
receiving, by a data processing system, a natural language query from a user computing device;
determining, by the data processing system, a plurality of topics associated with the natural language query;
identifying, by the data processing system, two or more entities each associated with at least a respective one or more of the plurality of topics;
determining, for each entity of the two or more entities, by the data processing system, a weighted score for the entity based on i) a projected quality of an answer to the query provided by the entity and ii) an availability of the entity to provide the answer to the query;
ranking, by the data processing system, the entities of the two or more entities based at least in part on the weighted score for each of the two or more entities;
obtaining, by the data processing system, an answer to the natural language query from a top ranked entity according to the ranking, the answer including one or more terms;
obtaining, by the data processing system, search results using the one or more terms of the answer as query terms, wherein each of the search results identifies a respective resource by a respective hyperlink;
integrating, by the data processing system, the answer with one or more of the hyperlinks to provide an integrated response that includes the one or more of the hyperlinks with the answer; and
providing, by the data processing system, an electronic document including the integrated response to the user computing device.

41. The method of claim 40, further comprising:
converting the natural language query from a first format to a second format used in a social search service environment,
wherein providing further comprises providing the electronic document in the second format.

42. The method of claim 40, wherein determining the plurality of topics associated with the natural language query includes:
parsing the natural language query for at least one keyword or phrase;
comparing the at least one keyword or phrase to a topic classification taxonomy; and
identifying, based on the comparison, at least one topic from the topic classification taxonomy associated with the query.

43. The method of claim 42, wherein determining the plurality of topics associated with the natural language query further includes:
identifying at least one semantically similar topic to the identified at least one topic from the topic classification taxonomy; and
associating the at least one semantically similar topic to the query.

44. The method of claim 42, wherein determining the plurality of topics associated with the natural language query further includes:
parsing the query and identifying at least one location-sensitive keyword or phrase in the query;
associating the query with a topic associated with the location-sensitive keyword or phrase.

45. (canceled)

46. (canceled)

47. The method of claim 40, wherein the projected quality of answer provided by the entity is calculated based on one or more of the following:
a set of topics identified by the entity as topics for which the entity has expertise;
a set of feedback information from at least one user based on previous answers provided by the entity; and
information on previous successful answers and associated topics provided by the entity.

48. The method of claim 40, wherein determining the plurality of topics associated with the natural language query includes:
retrieving a tag included in the query;
identifying at least one topic from a topic classification taxonomy associated with the tag; and
associating the at least one identified topic with the query.

49. A system comprising:
one or more computers; and
a computer-readable medium coupled to the one or more computers having instructions stored thereon which, when executed by the one or more computers, cause the one or more computers to perform operations comprising:
receiving, by a data processing system, a natural language query from a user computing device;
determining, by the data processing system, a plurality of topics associated with the natural language query;
identifying, by the data processing system, two or more entities each associated with at least a respective one or more of the plurality of topics;
determining, for each entity of the two or more entities, by the data processing system, a weighted score for the entity based on i) a projected quality of an answer to the query provided by the entity and ii) an availability of the entity to provide the answer to the query;
ranking, by the data processing system, the entities of the two or more entities based at least in part on the weighted score for each of the two or more entities;
obtaining, by the data processing system, an answer to the natural language query from a top ranked entity according to the ranking, the answer including one or more terms;
obtaining, by the data processing system, search results using the one or more terms of the answer as query terms, wherein each of the search results identifies a respective resource by a respective hyperlink;
integrating, by the data processing system, the answer with one or more of the hyperlinks to provide an integrated response that includes the one or more of the hyperlinks with the answer; and
providing, by the data processing system, an electronic document including the integrated response to the user computing device.

50. The system of claim 49, the operations further comprising:
converting the natural language query from a first format to a second format used in a social search service environment,
wherein providing further comprises providing the electronic document in the second format.

51. The system of claim 49, wherein determining the plurality of topics associated with the natural language query includes:
parsing the natural language query for at least one keyword or phrase;
comparing the at least one keyword or phrase to a topic classification taxonomy; and
identifying, based on the comparison, at least one topic from the topic classification taxonomy associated with the query.

52. The system of claim 51, wherein determining the plurality of topics associated with the natural language query further includes:
identifying at least one semantically similar topic to the identified at least one topic from the topic classification taxonomy; and
associating the at least one semantically similar topic to the query.

53. The system of claim 51, wherein determining the plurality of topics associated with the natural language query further includes:
parsing the query and identifying at least one location-sensitive keyword or phrase in the query; and
associating the query with a topic associated with the location-sensitive keyword or phrase.

54. (canceled)

55. (canceled)

56. The system of claim 49, wherein the projected quality of answer provided by entity is calculated based on one or more of the following:
a set of topics identified by the entity as topics for which the entity has expertise;
a set of feedback information from at least one user based on previous answers provided by the entity; and
information on previous successful answers and associated topics provided by the entity.

57. A non-transitory computer-readable medium storing software comprising instructions executable by one or more computers which, upon such execution, cause the one or more computers to perform operations comprising:
receiving, by a data processing system, a natural language query from a user computing device;
determining, by the data processing system, a plurality of topics associated with the natural language query;
identifying, by the data processing system, two or more entities each associated with at least a respective one or more of the plurality of topics;
determining, for each entity of the two or more entities, by the data processing system, a weighted score for the entity based on i) a projected quality of an answer to the query provided by the entity and ii) an availability of the entity to provide the answer to the query;
ranking, by the data processing system, the entities of the two or more entities based at least in part on the weighted score for each of the two or more entities;
obtaining, by the data processing system, an answer to the natural language query from a top ranked entity according to the ranking, the answer including one or more terms;
obtaining, by the data processing system, search results using the one or more terms of the answer as query terms, wherein each of the search results identifies a respective resource by a respective hyperlink;
integrating, by the data processing system, the answer with one or more of the hyperlinks to provide an integrated response that includes the one or more of the hyperlinks with the answer; and
providing, by the data processing system, an electronic document including the integrated response to the user computing device.

58. The computer-readable storage medium of claim 57, wherein determining the plurality of topics associated with the natural language query includes:
parsing the natural language query for at least one keyword or phrase;
comparing the at least one keyword or phrase to a topic classification taxonomy; and
identifying, based on the comparison, at least one topic from the topic classification taxonomy associated with the query.

59. The computer-readable medium of claim 58, wherein determining the plurality of topics associated with the natural language query further includes:
identifying at least one semantically similar topic to the identified at least one topic from the topic classification taxonomy; and
associating the at least one semantically similar topic to the query.
